(19) United States
(12) Patent Application Publication
(10) Pub. No.: US 2010/0178023 A1
(43) Pub. Date: Jul. 15, 2010

(54) OPTICAL INTERFACE DEVICE

(76) Inventor: MASAYUKI FUKAI, Tokyo (JP)

Correspondence Address: Mr. Jackson Chen, 6535 N. STATE HWY 161, IRVING, TX, 75039, US

(21) Appl. No.: 12/687,693

(22) Filed: Jan. 14, 2010

(30) Foreign Application Priority Data
Jan. 15, 2009 (JP) 2009-006926

(51) Int. Cl. G02B 6/00

(52) U.S. Cl. 385/140

(57) ABSTRACT

An optical interface device comprises an optical fuse and an optical attenuator in this order along an optical transmission path.

### REFERENCE TO RELATED APPLICATION

This application is based upon and claims the benefit of the priority of Japanese patent application No. 2009-006926, filed on Jan. 15, 2009, the disclosure of which is incorporated herein in its entirety by reference thereto.

### TECHNICAL FIELD

The present invention relates to an optical interface device, and particularly to an optical interface device capable of cutting off light.

### BACKGROUND

In a long-distance/large-capacity optical transmission system, a rare earth element-doped optical fiber amplifier that directly amplifies a transmitted signal light is used in order to increase the transmission distance. A pulsed high level signal light component (called “optical surge” hereinafter) that secondarily occurs while such a system changes from a state in which no signal light is supplied to the rare earth element-doped optical fiber amplifier to a state in which it is supplied causes the deterioration of optical parts (refer to Patent Document 1).

Patent Document 1 discloses an optical fuse capable of reducing transmitted light or reflected light by using a surface that irreversibly changes at least one of the reflectance or the transmittance in an instant when an optical power larger than a predetermined value is incident on it, thereby cutting off the output to an optical output unit. By using such an optical fuse, it is possible to prevent optical parts disposed in subsequent stages from being damaged.
[Patent Document 1]

Japanese Patent Kokai Publication No. JP-A-11-274547

### SUMMARY

The entire disclosure of Patent Document 1 is incorporated herein by reference thereto.

The following analysis is given by the present invention.

During the operation of an optical transmission system, if the light level on the transmission end suddenly and unexpectedly changes and increases due to some factors such as a malfunction, damage to a circuit on the reception end can be prevented by the optical fuse of Patent Document 1. However, optical fuse generally has some delay between the reception of an optical surge and the cutoff of the optical signal. Therefore, during this delay, the optical surge may leak over to later stages and damage a circuit on the reception end.

It is an object of the present invention to provide an optical interface device that prevents a circuit on the reception end from being damaged by an optical surge leaked by an optical fuse.

An optical interface device relating to an aspect of the present invention comprises an optical fuse and an optical attenuator in this order along an optical transmission path.

The meritorious effects of the present invention are summarized as follows.

According to the present invention, damage to a circuit on the reception end caused by an optical surge leaked by an optical fuse can be prevented.

### BRIEF DESCRIPTION OF THE DRAWINGS

FIG. 1 is a block diagram showing the configuration of an optical interface device relating to a first exemplary example of the present invention.

FIG. 2 is a block diagram showing the configuration of an optical interface device relating to a second exemplary example of the present invention.

FIG. 3 is a block diagram showing the configuration of an optical interface device relating to a third exemplary example of the present invention.

FIG. 4 is a block diagram showing the configuration of an optical transmission system relating to a fourth exemplary example of the present invention.

### PREFERRED MODES

An optical interface device relating to a mode of the present invention comprises an optical fuse and an optical attenuator in this order along an optical transmission path.

The optical interface device may further comprise another optical attenuator immediately before (upstream of) the optical fuse in the transmission path.

The optical interface device may further comprise another optical fuse subsequent to (downstream of) the optical attenuator in the transmission path.

According to another aspect of the present invention, an optical transmission system may comprise the optical interface device described above between an optical transmitter and an optical receiver.

The optical interface device described above can protect a circuit on the reception end by attenuating the light that leaks over to later stages before the optical fuse cuts off the optical signal since there is an optical attenuator behind the optical fuse. Further, since the optical interface device is inserted between the optical transmitter and the optical receiver, the device can be applied to various devices having an optical interface.

### Exemplary Example 1

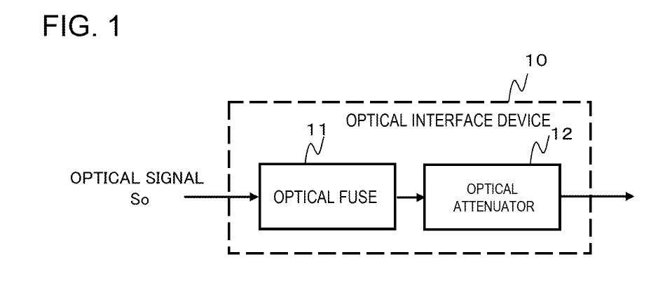

FIG. 1 is a block diagram showing the configuration of an optical interface device relating to a first exemplary example of the present invention. In FIG. 1, the optical interface device 10 comprises an optical fuse 11 and an optical attenuator 12 in this order along an optical transmission path. The optical fuse 11 receives an optical signal So, lets it pass, and outputs the signal to the optical attenuator 12. The optical fuse 11 cuts off the path and stops outputting when the level of the optical signal So fed to the optical fuse 13 suddenly and unexpectedly changes and the input level increases. The optical attenuator 12 attenuates the level of the received optical signal by a predetermined amount and outputs the signal to the outside. Further, the optical attenuator 12 may perform optical attenuation by a variable or fixed amount.

According to the optical interface device 10 as described, a circuit on the reception end can be protected by attenuating the light that leaks over to later stages before the optical fuse 11 cuts off the optical signal since there is the optical attenuator 12 behind the optical fuse 11.

### Exemplary Example 2

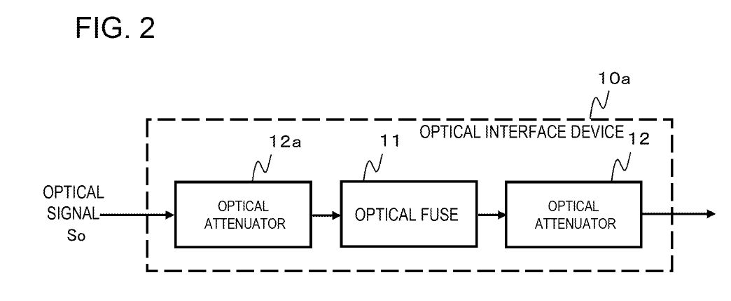

FIG. 2 is a block diagram showing the configuration of an optical interface device relating to a second exemplary example of the present invention. In FIG. 2, the optical interface device 10a comprises an optical attenuator 12a and an optical attenuator 12 with the optical fuse 11 interposing therebetween along an optical transmission path.

According to the optical interface device 10a as described, by utilizing the two optical attenuators with the optical fuse interposing between them, the direction of optical transmission is not restricted, compared to the configuration in FIG. 1. Therefore, light can be supplied from either side. Further, in FIG. 2, the optical signal So is fed to the optical attenuator 12a, however, the signal can be fed from the other side as well.

### Exemplary Example 3

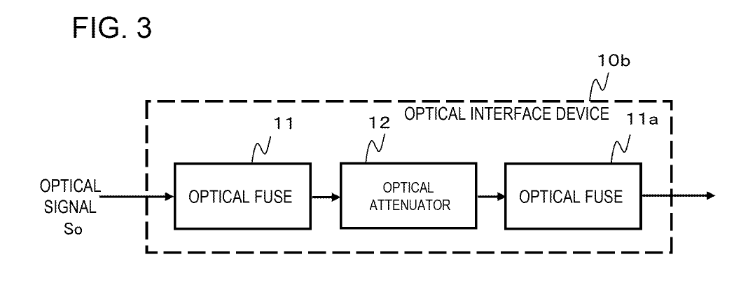

FIG. 3 is a block diagram showing the configuration of an optical interface device relating to a third exemplary example of the present invention. In FIG. 3, the optical interface device 10b comprises the optical fuse 11 and an optical fuse 11a with the optical attenuator 12 interposing therebetween along an optical transmission path.

According to the optical interface device 10b as described, by providing the optical fuses on both sides of the optical attenuator, the direction of optical transmission does not become an issue as in the second exemplary example. Further, in FIG. 3, the optical signal So is fed to the optical fuse 11, however, the signal can be fed from the other side as well.

### Exemplary Example 4

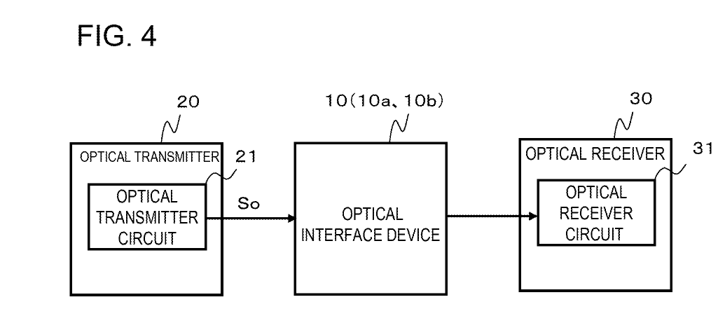

Next, an exemplary example in which the optical interface device described above is applied to an optical transmission system will be described. FIG. 4 is a block diagram showing the configuration of an optical transmission system relating to a fourth exemplary example of the present invention. In FIG. 4, the optical transmission system comprises the optical interface device 10 (10a, 10b) between an optical transmitter 20 and an optical receiver 30.

An optical transmitter circuit 21 in the optical transmitter outputs the optical signal So to an optical receiver circuit 31 in the optical receiver 30 via the optical interface device 10 (10a, 10b).

The optical transmission system normally adjusts the level of the signal according to the reception level of the optical receiver 30 using the optical interface device 10 (10a, 10b) so that the level of the signal is within the normal reception range of the optical receiver 30. The optical signal adjusted to be in the normal range is received by the optical receiver circuit 31 in the optical receiver 30.

If the optical transmission level suddenly increases in this state due to a malfunction of the optical transmitter circuit 21 of the optical transmitter 20, the optical fuse inside the optical interface device 10 (10a, 10b) is blown out. Therefore, the output of the optical interface device 10 (10a, 10b) can be stopped before the optical signal with the increased level is outputted to the optical receiver circuit 31 of the optical receiver 30. Further, the optical receiver circuit 31 can be protected by having the attenuator of the optical interface device 10 (10a, 10b) attenuate the optical signal that has leaked before the fuse is blown out.

Further, if the optical transmitter 20 malfunctions, it can be restored to a normal state by exchanging the optical transmitter circuit 21 in the optical transmitter 20 with a normal one and changing the optical interface device 10 (10a, 10b).

In the optical transmission system described above, the receiver can be protected when the level of the optical signal suddenly changes, and parts malfunctioning can be easily exchanged because of the protection.

Further, the each disclosure of the aforementioned Patent Document is incorporated herein by reference thereto.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An optical interface device comprising an optical fuse and an optical attenuator in this order along an optical transmission path.

2. The optical interface device as defined in claim 1 further comprising another optical attenuator immediately upstream of said optical fuse in the optical transmission path.

3. The optical interface device as defined in claim 1 further comprising another optical fuse downstream of said optical attenuator in the optical transmission path.

4. An optical transmission system comprising the optical interface device as defined in claim 1 between an optical transmitter and an optical receiver.

5. An optical transmission system comprising the optical interface device as defined in claim 2 between an optical transmitter and an optical receiver.

6. An optical transmission system comprising the optical interface device as defined in claim 3 between an optical transmitter and an optical receiver.

7. An optical interface device comprising an optical attenuator, an optical fuse and another optical attenuator in this order along an optical transmission path.

8. An optical interface device comprising an optical fuse, an optical attenuator and another optical fuse in this order along an optical transmission path.

9. An optical transmission system comprising the optical interface device as defined in claim 7.

10. An optical transmission system comprising the optical interface device as defined in claim 8.
